(19) United States
(12) Patent Application Publication
(10) Pub. No.: US 2003/0041396 A1
(43) Pub. Date: Mar. 6, 2003

(54) POWER HANDLE FOR ELECTRIC TOOTHBRUSH WITH HAND GRIP CONFIGURATION

(76) Inventor: Robert G. Dickie, Newmarket (CA)

Correspondence Address: MARKS & CLERK, 350 BURNHAMTHORPE ROAD WEST, SUITE 402, MISSISSAUGA, ON, L5B 3J1, CA

(21) Appl. No.: 09/943,761

(22) Filed: Sep. 4, 2001

(51) Int. Cl. A61C 17/22

(52) U.S. Cl. 15/22.1

(57) ABSTRACT

A power handle for electric toothbrushes is adapted to have a toothbrush head assembly placed thereon for delivery of driving power to the toothbrush head assembly. The power handle comprises a generally U-shaped battery compartment portion, a power delivery neck portion, and an end cap portion, and an electric motor installed within the power handle in a coupled power delivery relationship to the power delivery neck portion. The battery compartment portion has first and second legs arranged in parallel relationship one to the other. Typically, each leg is hollow, and has a length and a minimum inside dimension which is sufficient to receive a standard battery such as an AA battery. The power delivery neck portion, electric motor, and first leg of the battery compartment are aligned one with another; with an electric switch being mounted on them. The end cap portion spans across the ends of the first and second hollow legs so as to close them and so as to secure a battery in place inside at least one of the two legs.

### FIELD OF THE INVENTION

This invention relates to electric toothbrushes, and particularly to power handles which are employed for various kinds of electric toothbrushes. The present invention provides a power handle that has a hand grip configuration, so that it may be used by children, geriatric patients and others having physical disabilities which may affect their fine motor skills, as well as by any other person intending to use and electric toothbrush.

### BACKGROUND OF THE INVENTION

Electric toothbrushes are very well known. They have been provided to the market for several decades, and generally they comprise a power handle and a toothbrush head assembly. Usually, but not always, the toothbrush head assembly is detachable from the power handle.

There are several reasons for providing a detachable toothbrush head assembly for electric toothbrushes. The first is, of course, that the same power handle for the electric toothbrush may well be employed by several members of a family, each using their own detachable head assembly. This, of course, replicates the typical situation in a family, and elsewhere, where people are reluctant to share a toothbrush, but may be quite amenable to sharing many other facilities and resources including toothpaste, small household appliances, and the like.

Another reason, of course, for providing detachable toothbrush head assemblies for electric toothbrushes is that the toothbrush bristle portion of the detachable head assembly will typically wear out in a period of several months, or so. Manufacturing technology is such that the cost of producing and replacing a detachable toothbrush head assembly with a new one is quite inexpensive, especially when it is compared with the costs of producing the power handle for the electric toothbrush.

Typically, power handles for electric toothbrushes, especially in modern days, have a battery or batteries enclosed therein rather than simply comprising a base handle having a motor therein and a flexible power lead which plugs into a convenient electrical wall socket. This permits much greater portability for the toothbrush, whereby it may be carried from one room to another; or more particularly, whereby the electric toothbrush may be carried by the owner or owners while travelling.

Thus, power handles for electric toothbrushes that enclose a battery or batteries within the handle will, themselves, comprise one of two varieties. The first is those which enclose a rechargeable battery within the handle; and the second variety is the kind of power handle which encloses a battery or batteries that will be replaced from time to time.

It is the latter variety of power handles for electric toothbrushes that the present invention is directed to.

Whether the toothbrush head assembly includes a bristle head which is rotary or which is otherwise oscillatory in one fashion or another, and whether or not the toothbrush head assembly is detachable or is fixed, they are typically driven by driving power delivered through a rotating shaft from an electric motor enclosed within the power handle for the electric toothbrush.

It has been found that power handles for electric toothbrushes which employ replaceable batteries will typical employ two AA batteries. Those batteries have standardized dimensions of diameter and length, although their power output may vary depending on their type to some extent.

Typically, a power handle for an electric toothbrush that employs two AA batteries contemplates the use of alkaline batteries—which are the standard batteries now supplied to the market throughout the world, in AA size.

However, all known power handles for electric toothbrushes which are designed to contain two AA batteries are designed so as to place the batteries either in end-to-end alignment, or in a side-to-side arrangement. The electric motors that are enclosed within the power handles for electric toothbrushes are typically rated for nominal operating voltage of 3 volts, and thus the batteries are employed in a series connected relationship.

In a power handle where two AA batteries are employed and are aligned in end-to-end relationship, the length of the power handle becomes excessive. On the other hand, where the power handle employs two AA batteries that are arranged in side-to-side configuration, then the thickness or diameter of the handle may become excessive.

Other battery arrangements, where the battery or batteries is/are to be replaced, are also contemplated to be within the scope fo the present invention, although such battery arrangements for power handles for electric toothbrushes are not typical. For example, AAA batteries might be used, the batteries might be either primary or secondary (rechargeable), and they might comprise more exotic electrical systems such as Nickel Metal Hydroxide (NiMH) or Lithium Ion (Li ion) systems. However, any such battery system is not likely to employ battery or batteries having a size larger than AA.

There are a number of individuals who would benefit from the use of an electric toothbrush for their dental hygiene needs, but who find difficulty in employing electric toothbrushes of the kind which are presently found in the market. Those persons include small children—typically, those children in the range from 3 years up to 6 or 7 years—because the hands of those children are not large enough to conveniently hold the power handle if it employs batteries in side-to-side arrangement. If the power handle employs batteries in end-to-end alignment, then such electric toothbrushes tend to be unbalanced, and unwieldy due to their length.

Other individuals who find difficultly in using conventional electric toothbrushes include developmentally challenged individuals, and those who for some reason such as illness or age, have lost their fine motor skills. Such individuals will particularly include geriatric patients, and any individuals of advanced age.

Also, such persons, particularly persons of advanced age, may have severely crippled or arthritic hands, once again making it difficult to grasp and control a conventional power handle for a conventional power toothbrush.

The present inventor has quite unexpectedly discovered that all of the difficulties and shortcomings of conventional electric toothbrushes as they are described above, particularly those toothbrushes which are designed to employ two AA batteries for their power source, can be overcome by providing a novel power handle configuration whereby the power handle is in the shape of a hand grip, having a passageway through which the fingers of the hand can be placed.

A power handle for electric toothbrushes, in keeping with the present invention, provides a number of advantages.

First, the power handle is reasonably well balanced, and it is relatively short, due to the placement of the batteries in separated arms which comprise the hand grip configuration of the power handle.

Further, the diameter of the power handle may be made considerably smaller than conventional power handles where batteries are placed in side-to-side arrangement, because the outside dimensions of each leg of the hand grip configuration need not be much greater than the outside diameter of a AA battery. At the same time, because of the arrangement of the batteries, with one on each leg of the hand grip configuration, a relatively short power handle is provided.

Another advantage of the power handle in keeping with the present invention is that by aligning the detachable toothbrush head with the electric motor within the power handle, as is required in any event, and further aligning that arrangement with one of the two batteries, and placing a control switch along the same alignment, the use of the power handle and the electric toothbrush which comprises the power handle, including controlling its on and off functions, are quite intuitive even for small children and other developmentally challenged individuals.

Thus, a power handle for electric toothbrushes which provides the ability to use an electric toothbrush for improved dental hygiene, especially by individuals who previously could not or were incapable of using an electric toothbrush by themselves, is provided in keeping with the teachings herein.

### SUMMARY OF THE INVENTION

To that end, the present invention provides a power handle for toothbrushes, which power handle is adapted to have a toothbrush head assembly placed thereon for delivery of driving power from the power handle to the toothbrush head assembly, where the power handle comprises a generally U-shaped battery compartment portion, a power delivery neck portion, and an end cap portion.

An electric motor is installed within the power handle in coupled power delivery relationship to the power delivery neck portion of the power handle.

The U-shaped battery compartment portion has first and second legs which are arranged in parallel relationship one to the other. At least on one of the legs has a length and minimum inside dimension which is sufficient to receive at least one battery.

The power delivery neck portion, the electric motor, and the first leg of the battery compartment are aligned one with another.

An electric switch for the power handle is mounted on the aligned power delivery neck portion, electric motor, and first leg of the battery compartment.

The end cap portion spans across the ends of the first and second hollow legs so as to close them, and so as to secure a battery in place inside at least one of the legs.

Typically, the power handle is adapted so that the toothbrush head assembly may be detached from the handle; in other words, the toothbrush head assembly is detachable.

Moreover typically each of the first and second legs is hollow, and each hollow leg is adapted to receive an electric battery therein.

If so, each of the first and second hollow legs will be adapted to receive an electric battery which may be chosen from the group consisting of primary AA cells, secondary AA cells, primary AAA cells, secondary AAA cells, NiMH cells having a physical size not greater than an AA cell, and Li ion cells having a physical size not greater than an AA cell.

The side of the first hollow leg which faces the second hollow leg may be configured with a plurality of finger hold ridges. Such an arrangement provides an enhanced gripping capability for such as the hands of small children, users who do not have or have lost their fine motor skills, and users who have such as crippled or arthritic hands.

The power delivery neck portion is adapted to receive a detachable toothbrush head assembly having a plurality of toothbrush bristles at an end thereof which is remote from the power delivery neck portion. The alignment of the toothbrush bristles will be in a direction which is perpendicular to the alignment of the first hollow leg, the electric motor, and the power delivery neck portion, and in an orientation away therefrom.

Thus, once again, the use of an electric toothbrush which employs a power handle in keeping with the present invention, is quite intuitive.

Within the power handle of the present invention, the electrical circuit includes two AA batteries, the electric motor, and the electric switch. Typically, the electric circuit is completed only when the end cap portion is in place across the ends of the first and second hollow legs, and the batteries are in place within the first and second hollow legs.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a perspective view of an electric toothbrush having a power handle in keeping with the present invention, and a detachable toothbrush head assembly secured thereon;

FIG. 2 is a view similar to FIG. 1, but in partial cross-section, and where the end cap portion has been detached;

FIG. 3 is a plan view of an assembled electric toothbrush including the power handle of the present invention, in cross-section;

FIG. 4 is a top view of an assembled electric toothbrush including the power handle of the present invention, showing placement of the electric switch; and

FIG. 5 is a side elevation of the assembled electric toothbrush of FIG. 4.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following discussion.

A typical electric toothbrush which employs a power handle in keeping with the present invention is shown in the drawings at 12. The toothbrush 12 comprises a power handle 10 and a toothbrush head assembly 14. Typically, the toothbrush head assembly 14 is detachable.

As is well known, and as will be described in any event hereafter, a detachable toothbrush head assembly 14 is placed on the power handle 10 for delivery of driving power from the power handle 10 to the detachable toothbrush head assembly 14.

Moreover, the following discussion and description is particularly directed to atypical power handle for electric toothbrushes, where the toothbrush head assembly is detachable, and where the electrical power is derived from two AA batteries.

The power handle 10 comprises a generally U-shaped battery compartment portion 20, a power delivery neck portion 22, and an end cap portion 24.

Within the power handle 10, there is installed an electric motor 30 which is coupled as at 32, in power delivery relationship, to the power delivery neck portion 22. The details of the electric motor and the power delivery relationship to the power delivery neck portion 22 are beyond the scope of the present invention.

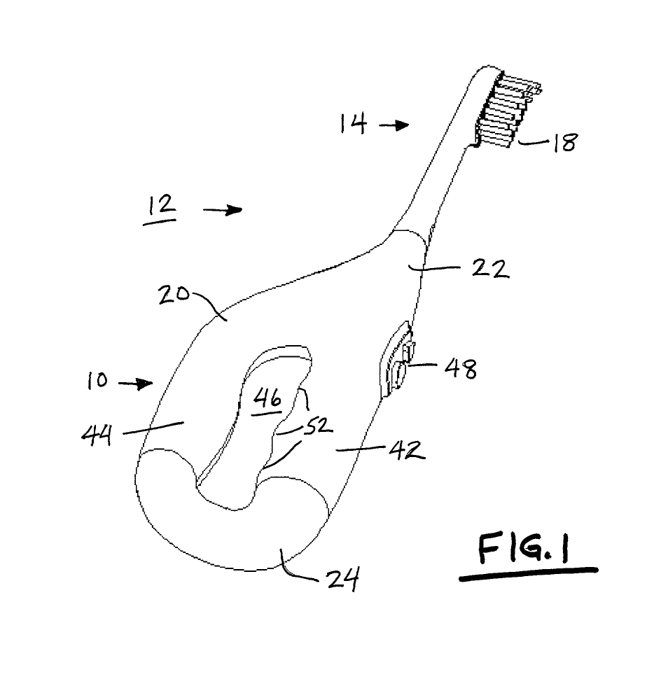

The battery compartment portion 20 has first and second hollow legs 42 and 44, respectively. As seen in any of FIGS. 1 to 3, and 5, the first and second hollow legs 42, 44 are arranged in parallel relationship one to the other.

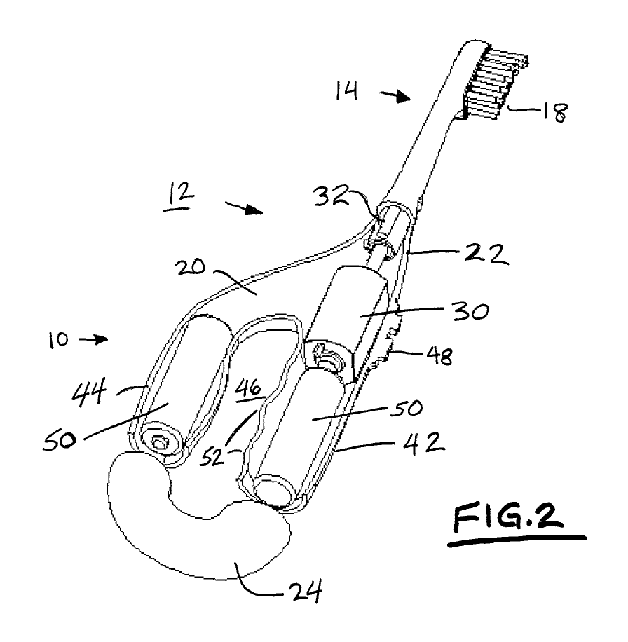

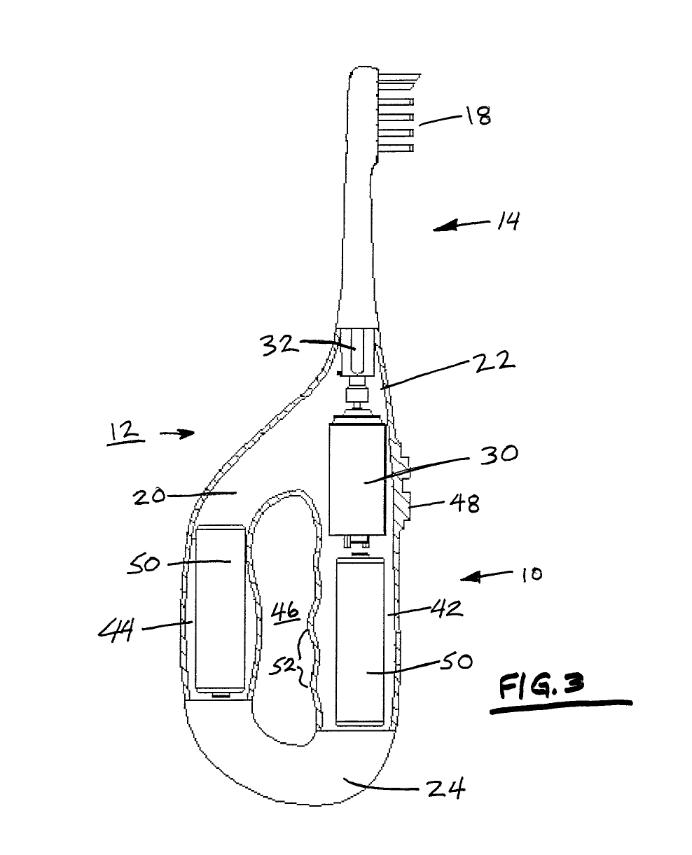

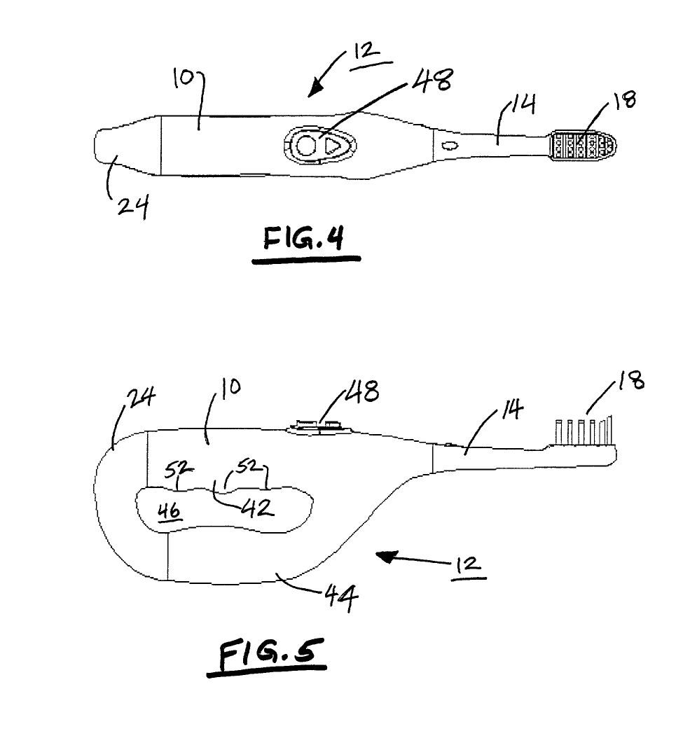

It will be clearly understood from FIGS. 2 and 3 that each of the hollow legs 42 and 44 has a length and a minimum inside dimension which is sufficient to receive a standard AA battery 50.

It will also be clearly understood from FIGS. 2 and 3, in particular, that the power delivery neck portion 22, the electric motor 30, and the first leg 42 of the battery compartment 20 are aligned one with another. Thus, when a hand of the user grips the first leg 42, with the fingers passing through opening 46, it will be clearly understood that the use of the power handle is quite intuitive and that it is balanced because of the weight of the second AA battery 50 within the hollow leg 44.

An electric switch arrangement 48 is provided on the power handle, and it is seen that it is mounted on the aligned power delivery neck portion 22, electric motor 30, and first leg 42 of the battery compartment 20.

Again, the intuitiveness of the operation is understood, because the thumb of the hand easily overlies the electric switch 48. Again, this is important because it is intended that the power handle of the present invention may be used not only by ordinary individuals, but by children, developmentally challenged individuals, persons who have lost fine motor skill, geriatric patients, others with crippled and arthritic hands, and so on.

Finally, it will be seen that the end cap portion 24 spans across the ends of the first and second legs 42, 44 so as to close them and so as to secure an AA battery 50 in place inside each one of the first and second hollow legs 42, 44.

Thus, there is provided a compact electric power handle for an electric toothbrush whose use is easy and intuitive, which is balanced, and which may be held by such as children and others, as noted above.

So as to enhance the hand grip configuration of the power handle of the present invention, the side of the first hollow leg 42 which faces the second hollow leg 44 may be configured with a plurality of finger hold ridges 52. This increases the utility of the power handle of the present invention, particularly for such individuals as small children.

As noted, the power handle 10 has the power delivery neck portion 22 which is adapted to receive a detachable toothbrush head assembly 14. By way of example only, a typical toothbrush bristle arrangement is shown at 18; but it will be clearly understood that the toothbrush bristle arrangement might as easily be a rotary bristle head, a double head, or other toothbrush bristle arrangements—all of which are beyond the scope of the present invention.

In any event, the coupling of the detachable toothbrush head assembly 14 to the power handle 10 is such that the alignment of the toothbrush bristles will be in a direction which is perpendicular to the alignment of the first hollow leg, the electric motor, and the power delivery neck portion, and in an orientation which is away therefrom.

Because the electrical arrangement within the power handle of the present invention is beyond the scope of the present invention, it is not detailed. However, typically, as noted above, the AA batteries 50 are arranged so as to be in series connection one with the other, together with the switch 48 and the electric motor 30. If so, although not absolutely necessary, it is usual that the electric circuit will be completed only when the end cap portion 24 is in place across the ends of the first and second hollow legs, as shown in FIGS. 1 and 3, for example, and of course that there are batteries 50 in place within the first and second hollow legs 42, 44.

There has been described a power handle for electric toothbrushes which provides an easily manipulated, intuitive, balanced, and small sized power handle such that it may be employed by children, developmentally challenged individuals, persons with crippled or arthritic hands, geriatric patients, and the like. That is, persons who have underdeveloped, yet to be developed, or who have lost their fine motor skills, may still enjoy better dental hygiene which is typically available because of the use of electric toothbrushes; especially when compared with the use by such individuals of manual toothbrushes.

Optional arrangements have been noted, including electric toothbrush assemblies where the toothbrush head assembly is fixed and is not detachable; and a variety of battery systems have also been noted.

Other modifications and alterations may be used in the design and manufacture of the apparatus of the present invention without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

What is claimed is:

1. A power handle for electric toothbrushes, which power handle is adapted to have a toothbrush head assembly placed thereon for delivery of driving power from said power handle to the toothbrush head assembly, said power handle comprising:
a generally U-shaped battery compartment portion, a power delivery neck portion, and an end cap portion; and
an electric motor being installed within said power handle in a coupled power delivery relationship to said power delivery neck portion;
wherein said battery compartment portion has first and second legs arranged in parallel relationship one to the other, and wherein at least one of said legs is hollow, and has a length and a minimum inside dimension which is sufficient to receive at least one battery;
wherein said power delivery neck portion, said electric motor, and said first leg of said battery compartment are aligned one with another;
wherein an electric switch for said power handle is mounted on said aligned power delivery neck portion, electric motor, and first leg of said battery compartment; and
wherein said end cap portion spans across the ends of said first and second legs so as to close them and so as to secure a battery in place inside said at least one leg.

2. The power handle of claim 1, wherein said power handle is adapted for said toothbrush head assembly to be detachable therefrom.

3. The power handle of claim 1, wherein each of said first and second legs is hollow, and each hollow leg is adapted to receive an electric battery therein.

4. The power handle of claim 2, wherein each of said first and second legs is hollow, and each hollow leg is adapted to receive an electric battery therein.

5. The power handle of claim 1, wherein each of said first and second hollow legs is adapted to receive an electric battery chosen from the group consisting of primary AA cells, secondary AA cells, primary AAA cells, secondary AAA cells, NiMH cells having a physical size not greater than an AA cell, and Li ion cells having a physical size not greater than an AA cell.

6. The power handle of claim 2, wherein each of said first and second hollow legs is adapted to receive an electric battery chosen from the group consisting of primary AA cells, secondary AA cells, primary AAA cells, secondary AAA cells, NiMH cells having a physical size not greater than an AA cell, and Li ion cells having a physical size not greater than an AA cell.

7. The power handle of claim 4, wherein each of said first and second hollow legs is adapted to receive an electric battery chosen from the group consisting of primary AA cells, secondary AA cells, primary AAA cells, secondary AAA cells, NiMH cells having a physical size not greater than an AA cell, and Li ion cells having a physical size not greater than an AA cell.

8. The power handle of claim 1, wherein the side of said first leg which faces said hollow leg is configured with a plurality of finger hold ridges.

9. The power handle of claim 3, wherein the side of said first hollow leg which faces said second hollow leg is configured with a plurality of finger hold ridges.

10. The power handle of claim 4, wherein the side of said first hollow leg which faces said second hollow leg is configured with a plurality of finger hold ridges.

11. The power handle of claim 2, wherein said power delivery neck portion is adapted to receive a detachable toothbrush head assembly having a plurality of toothbrush bristles at an end thereof remote from said power delivery neck portion, where the alignment of said toothbrush bristles is in a direction perpendicular to the alignment of said first hollow leg, said electric motor, and said power delivery neck portion, and in an orientation away therefrom.

12. The power handle of claim 4, wherein said power delivery neck portion is adapted to receive a detachable toothbrush head assembly having a plurality of toothbrush bristles at an end thereof remote from said power delivery neck portion, where the alignment of said toothbrush bristles is in a direction perpendicular to the alignment of said first hollow leg, said electric motor, and said power delivery neck portion, and in an orientation away therefrom.

13. The power handle of claim 5, wherein an electrical circuit which includes two AA batteries, said electric motor, and said electric switch, is completed only when said end cap portion is in place across the ends of said first and second hollow legs, and said batteries are in place therewithin.

14. The power handle of claim 6, wherein an electrical circuit which includes two AA batteries, said electric motor, and said electric switch, is completed only when said end cap portion is in place across the ends of said first and second hollow legs, and said batteries are in place therewithin.

15. The power handle of claim 7, wherein an electrical circuit which includes two AA batteries, said electric motor, and said electric switch, is completed only when said end cap portion is in place across the ends of said first and second hollow legs, and said batteries are in place therewithin.
